(19) United States
(12) Patent Application Publication
(10) Pub. No.: US 2024/0407326 A1
(43) Pub. Date: Dec. 12, 2024

(54) PET BED CUSHION

(71) Applicant: Susan Ramos, Dover, FL (US)

(72) Inventor: Susan Ramos, Dover, FL (US)

(21) Appl. No.: 18/700,296

(22) PCT Filed: Nov. 3, 2022
(86) PCT No.: PCT/US2022/079194

§ 371 Date: Apr. 11, 2024

Related U.S. Application Data
(63) Continuation-in-part of application No. 29/842,925, filed on Jun. 16, 2022.
(60) Provisional application No. 63/360,838, filed on Nov. 3, 2021.

(51) Int. Cl. A01K 1/035

(52) U.S. Cl. CPC A01K 1/0353

(57) ABSTRACT

The invention relates to a pet bed cushion having an insert and the insert removably receiving at least one pillow/support material that can be removed and said insert can be washed is disclosed. The pet bed cushion insert with multiple pockets, each of which holds one or more of the pillow/support material while allowing the pillow/support material to be removed from and replaced into the respective pocket which permits the user to customize the pet bed cushion.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application claims the benefit of U.S. Provisional patent Application Ser. No. 63/360,838, filed on Nov. 3, 2021, and U.S. Design patent application Ser. No. 29/842,925 filed Jun. 16, 2022, both of which are incorporated by reference herein in their entirety.

### BACKGROUND OF THE INVENTION

### 1) Field of the Invention

The invention relates to the field of a pet bed cushion and particularly toward a pet bed cushion of more durable and washable construction.

### 2) Description of Related Art

Currently the state of the art includes countless pet beds, many of which have enjoyed considerable commercial success. Such beds are typically made of an outer fabric cover or duvet that is sewn in a manner that imparts a desired bed shape that is filled internally with a fill, such as a cotton or polyester fiber filling. Unfortunately, despite many of these beds starting out providing a comfortable bedding surface for a pet, problems remain. As a cat or dog continues to use their bed, it is common for the filling within the cover to become displaced, bunch up, or become lumpy adversely affecting comfort. With continued use, filling will actually work its way completely through the cover causing the bed to undesirably “shed” filling. In addition, some cats and dogs will bite, tear, or paw their bed which can increase wear and tear, reducing useful bed life.

Additionally, when the cover becomes soiled, the user is forced to wash the bed which causes the internal fill to lose the shape and support for the pet. During washing, the water-weighted fill tends to create off-balance issues/stoppages during the rinse and spin cycles. This results in frequent replacement (landfill load), or lack thereof due to costs.

What is needed is an improved pet bed that is not only more easily washable but more durable while remaining comfortable.

### BRIEF SUMMARY OF THE INVENTION

The instant invention in one form is directed to a washable pet bed cushion formed of a cover with an insert that has a plurality of compartments/pockets for removable cushions or pillows. The cover goes over an insert that has at least two pockets in which a cushion can be inserted. The insert's pockets can be filled with foam or fiber fill but is designed to hold any type of pillow or pillow material which is desired. In a preferred pet bed cushion, the insert is sewn with seams defining a plurality of pairs of pockets each receiving a cushion or pillow. Such a bed construction advantageously allows components of the bed, namely its cushions or pillows, to be removed from the insert enabling the cover and the now-empty insert to be machine washed.

In a first implementation of the invention, the pet bed cushion and the cover are formed so it includes a plurality of pairs of radially outwardly extending seams that help define a cushion insertion or removal opening in its side. The seams sewn into the insert also define a plurality of pockets spaced apart enabled to receive a pillow and the pocket can have a closure so that the pillow is captivated in the pocket. Alternatively, the pocket can have an opening that receives the pillow or cushion in the pocket and does not provide a closure mechanism. If the pocket has a closer or closure mechanism the closure mechanism can be selected from buttons and buttonholes, loop and hook closure of Velcro®, snap, zipper or a lace and holes closure mechanism.

The configuration of the instant invention allows the user to wash the insert or cover/duvet separately when it is soiled. This protects the pillow from losing the pillow shape or the ability to adequately support the pet when reinserted into the insert.

Another benefit of the instant invention is that it allows the user to insert the type and quality of pillow that they want. The user can use a low-cost pillow (the pet owner's old one, containing the owner's scent, which dogs love and are comforted by), a lower cost pillow or a high-cost high quality pillow depending on their situation or needs.

The pillow containing the cushioning material is inserted or removed through the insert closure opening. The ability to change the cover and insert allows the user to customize the pet bed cushion to suit the season and style of the owner and the needs of the pet.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a left front top perspective view of a first embodiment of the pet bed cushion of the instant invention.

FIG. 2 is a top plan view of the pet bed cushion of the instant invention shown in FIG. 1;

FIG. 3 is a bottom plan view of the pet bed cushion of the instant invention shown in FIG. 1;

FIG. 4 is a left side elevational view of the pet bed cushion of the instant invention shown in FIG. 1;

FIG. 5 is a front elevational view of the pet bed cushion of the instant invention shown in FIG. 1;

FIG. 6 is a right-side elevational view of the pet bed cushion of the instant invention shown in FIG. 1;

FIG. 7 is a rear elevational view of the pet bed cushion of the instant invention shown in FIG. 1;

FIG. 8 is a left front top perspective view of a second embodiment of the pet bed cushion of the instant invention;

FIG. 9 is a top plan view of the pet bed cushion of the instant invention shown in FIG. 8;

FIG. 10 is a bottom plan view of the pet bed cushion of the instant invention shown in FIG. 8;

FIG. 11 is a left side elevational view of the pet bed cushion of the instant invention shown in FIG. 8;

FIG. 12 is a front elevational view of the pet bed cushion of the instant invention shown in FIG. 8;

FIG. 13 is a right-side elevational view of the pet bed cushion of the instant invention shown in FIG. 8;

FIG. 14 is a rear elevational view of the pet bed cushion of the instant invention shown in FIG. 8;

FIG. 15 is a left front top perspective view of a third embodiment of the pet bed cushion of the instant invention design according to our invention;

FIG. 16 is a top plan view of the pet bed cushion of the instant invention shown in FIG. 15;

FIG. 17 is a bottom plan view of the pet bed cushion of the instant invention shown in FIG. 15;

FIG. 18 is a left side elevational view of the pet bed cushion of the instant invention shown in FIG. 15;

FIG. 19 is a front elevational view of the pet bed cushion of the instant invention shown in FIG. 15;

FIG. 20 is a right side elevational view of the pet bed cushion of the instant invention shown in FIG. 15;

FIG. 21 is a rear elevational view of the pet bed cushion of the instant invention shown in FIG. 15;

FIG. 22 is a left front top perspective view of a third embodiment of the pet bed cushion of the instant invention design according to our invention;

FIG. 23 is a top plan view of the pet bed cushion of the instant invention shown in FIG. 22;

FIG. 24 is a bottom plan view of the pet bed cushion of the instant invention shown in FIG. 22;

FIG. 25 is a left side elevational view of the pet bed cushion of the instant invention shown in FIG. 22;

FIG. 26 is a front elevational view of the pet bed cushion of the instant invention shown in FIG. 22;

FIG. 27 is a right-side elevational view of the pet bed cushion of the instant invention shown in FIG. 22;

FIG. 28 is a rear elevational view of the pet bed cushion of the instant invention shown in FIG. 22;

FIG. 29 is shown a closure formed from a button and buttonhole;

FIG. 30 is shown a side view of a closure in the unclosed state formed from a loop and hook closure mechanism;

FIG. 31 is shown a side view of a closure in the closed state formed from a loop and hook closure mechanism;

FIG. 32 is shown a closure formed from a zipper;

FIG. 33 is shown a view of the instant invention with optional aroma therapy insert; and

FIG. 34 is a kit of the instant invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms pillow and cushion are used interchangeably to mean a pillow or support material inserted into the cavity or pocket of the instant invention.

The terms cavity or pocket are used interchangeably to mean a pocket to insert the pillow or cushion of the instant invention into.

The term insert as used in the specification means a covering that is designed to receive at least one pillow to form a pet bed cushion and the pet bed cushion is designed to be placed into a duvet to cover the pet bed cushion.

Prior to a discussion of the preferred embodiment of the invention, it should be understood that while the features and advantages of the invention are illustrated in terms of a pet bed cushion the instant invention can be used in a variety of other situations where a comfortable and washable bed is need such as for a baby bed, a child's nap mat or bed or a portable bed for camping.

The instant invention is a device which is a washable pet bed cushion formed of an insert with at least one or a plurality of removable support material or pillows. The insert has at least two pockets in which pillows or other support material can be inserted. The insert can have two long sides and a short side which are formed by sewing opposing material to form the pocket or the insert can have three short sides which are formed by sewing opposing material to form the pocket. Alternatively, the insert can have three long sides which are formed by sewing opposing material to form the pocket. The pockets can be oriented so that the pockets are in communication with a short side of the opposing pockets, the long side of the opposing pockets, or the short side and long side of the opposing pockets. The insert can be filled with a pillow, foam or fiber fill or any type of support material which is desired. In a preferred pet bed cushion, the insert is sewed with seams defining a plurality of pairs of pockets each receiving support material or pillow. Such a bed construction advantageously allows components of the bed, namely the insert with its support material or pillows, to be removed from the cover/duvet and thereby enabling the cover/duvet and the insert to be machine washed without having to wash the pillow or support material. If required, the pillows/support material can be removed from the insert and it, too, can be laundered.

In a first implementation of the invention, the pet bed cushion and the insert are formed so that the insert includes a plurality of pairs of outwardly extending seams that help define a pillow/cushion insertion or removal opening in its side. The seams sewed into the insert also define a plurality of pairs of pockets spaced apart such that each are enabled to receive a pillow or support material and the pocket can have a closure so that the pillow is captivated in the pocket. Alternatively, the insert's pocket can have an opening that receives the pillow or support material in the pocket and does not provide a closure mechanism. If the insert's pocket has a closer or closure mechanism the closure mechanism can be selected from buttons and buttonholes, loop and hook closure or Velcro®, snap, zipper or a lace and holes closure mechanism. pillows.

The configuration of the instant invention allows the user to wash the cover/duvet and the insert separately when either are soiled. This protects the pillow or support material from losing the shape of the pillow/support material or the ability to adequately provide support for the pet when reinserted into the insert.

Another benefit of the instant invention is that it allows the user to use the type and quality of pillow they want. The user can use a no-cost (old) pillow that has the scent of the owner, a lower cost pillow, or a high-cost high quality pillow depending on their situation or needs.

The insert can be made from any suitable washable fabric material such as linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

The pillows or support material used with the insert can be selected from standard pillow, twin size pillow, queen size pillow or king size pillow. The support material for the insert can also be sheets, bedspreads, clothing, or other material already on-hand.

The instant invention is an insert for a pet bed cushion that has at least two pockets that can have two long sides and a short side which are formed by sewing opposing material to form the pocket or the least two pockets can have three short sides which are formed by sewing opposing material to form the pocket. Alternatively, the at least two pockets can have three long sides which are formed by sewing opposing material to form the pocket The pockets can be oriented so that the pockets are in communication with a short side of the pockets, the long side of the pockets, or the short side and long side of the pockets. When the pillow/support material and the insert are assembled they form an assembly and the assembly forms a pet bed cushion and that assembly can then be placed in a duvet that covers the pet bed cushion.

The pillow/support material insertion or removal is through the insert closure opening with a defining pocket that permits insertion of a pillow/support material that is a pillow, cushion or other stuffing material. The ability to change the pillow/support material allows the user to customize the pet bed cushion for the needs of the pet.

The instant invention can also be configured in an alternative embodiment such that an aroma therapy disposable (or item with the owner's scent) is placed between the pillow or cushion and the inside of the pocket of the insert. The aroma therapy disposable can fit into an aroma therapy pocket or placed loosely into the insert so that the aroma therapy disposable can emit the scent for the pet to smell. The aroma therapy disposable can contain any of the following or a combination of substances including but not limited to lavender, essential oils, Bergamot, Clary Sage, Peppermint, Eucalyptus, Lemon, Rosemary, Chamomile, Peppermint, vanilla, coconut, valerian, ginger, cannabis, catnip and Cannabidiol (CBD) oil. The use of aroma therapy products can have a soothing effect on a pet. It is well known that a dog's sense of smell is much stronger than that of humans; dogs have up to 220 million scent receptors in their noses, while humans have approximately five million. With such powerful olfactory capabilities, it is no surprise that scents can affect dogs' behavior and comfort levels. The benefit was proven by a team of British researchers that studied whether essential oils could reduce stress and improve the welfare of dogs in shelters. The answer was a resounding yes. “The behavioral effects of olfactory stimulation on dogs at a rescue shelter” (Applied Animal Behaviour Science, May 2018), focused on four scents: vanilla, coconut, valerian, and ginger. Fifteen dogs of different breeds, genders, ages, and sizes who had already stayed two to twenty-one months at two animal shelters in the United Kingdom were exposed to six different “olfactory conditions”-four different cloths scented with the essential oils, in addition to two controls (an unscented cloth and a control situation without any cloth present).

The dogs needed environmental enrichment. They were receiving just two 10-minute walks a day. Eight were former strays, four were owner surrenders, and three had been transferred from another shelter. The two-hour observation sessions were scheduled well away from the dogs' meals and walks to prevent anticipation from clouding the results. Researchers placed the cloths in the center of each enclosure, and the dogs were able to touch or otherwise “interact with” them.

The odors proved to have significant positive effects on stress indicators in the dogs. All four scented cloths led to lower levels of vocalizing (such as barking, growling, or whining) as well as less time spent pacing or moving during exposure to the oils, and more time resting. During exposure to the coconut and ginger samples, the dogs spent an increased amount of time sleeping.

The instant invention when used with the aroma therapy disposable helps calm the pet.

The instant invention comprises at least the following components:
a. an insert that is capable of holding at least two pillows or cushions.
b. at least two pillows.

The instant invention can also incorporate an aroma therapy disposable and will have an insert closure mechanism.

The assembly of all the items into a kit makes the use simple and easy for the user because the parts necessary for the user to assemble a pet bed cushion are present in one package (less the cushioning material). The kit would contain the insert, and an optional aroma therapy disposable and an optional duvet or cover.

The instant invention in a first embodiment can be described as a pet bed cushion comprising:
a. an insert made from a washable material having a fastenable opening into which the pillow/support material is placed. Three sizes of this combination are envisioned, but more are possible. The insert is produced with a differing number of pockets to yield the different size pet bed cushion. The insert's pockets are seamed/joined at standard pillow-sized spacing's;
b. the insert pockets are configured to removably receive a pillow/support material therein forming a pet bed cushion therewith;
c. the pockets can also removably receive an aroma therapy disposable;
d. the pockets of the insert have a closure mechanism to close the pocket when the pillow/support material is received within the pockets;
e. the insert is washable. The pillow/support material provided by the owner is removably held in a corresponding pocket in the insert such that each pillow is removable from and replaceable into the insert through the corresponding pocket opening. This allows easier washing and drying of the now-empty insert; and
f. the pillows and the insert are placed into a duvet if desired.

The pet bed cushion insert closure mechanism can be selected from the group consisting of buttons and buttonholes, loop and hook closure, snaps, zipper or a lace and holes closure mechanism.

The pet bed cushion insert of the first embodiment wherein the washable material for said insert is selected from the group consisting of linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

The pet bed cushion of the first embodiment wherein the at least one pocket of the insert is oriented so that there are two pockets attached together such that they are attached on the short side of the pocket.

The pet bed cushion of the first embodiment wherein the at least one pocket of the insert is oriented so that there are two pockets attached together such that they are attached on the long side of the pocket.

The pet bed cushion of the first embodiment wherein the aroma therapy disposable is selected from the group consisting or lavender, essential oils, Bergamot, Clary Sage, Peppermint, Eucalyptus, Lemon, Rosemary, Chamomile, Peppermint, vanilla, coconut, valerian, ginger, cannabis, catnip and Cannabidiol (CBD) oil.

The instant invention in a second embodiment can be described as a pet bed cushion comprising:
a. an insert with at least one pocket made from a washable material and each at least one pocket accommodates a pillow/support material or filler and each at least one pocket having a pocket opening on a short side of the pocket that permits access into and out of the respective pocket and the at least one pocket being joined at a long side of the pocket to a second at least one pocket long side;
b. the at least one pocket configured to removably receive a pillow/support material therein forming said pet bed cushion therewith;
c. the at least one pocket configured to removably receive an aroma therapy disposable;
d. the at least one pocket having a closure mechanism to close the pocket when the pillow/support material is received within the pockets;
e. each pillow/support material being removably held in a corresponding at least one pocket such that each pillow/support material is removable from and replaceable into the at least one pocket through the corresponding pocket opening; and
f. said pet bed cushion fitting into a duvet.

The pet bed cushion of the second embodiment wherein the closure mechanism of the insert is selected from the group consisting of buttons and buttonholes, loop and hook closure, snaps, zipper or a lace and holes closure mechanism.

The pet bed cushion of the second embodiment wherein the insert washable material is selected from the group consisting of linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

The pet bed cushion of the second embodiment wherein the insert at least one pocket is oriented so that there are two pockets attached together such that they are attached on the short side of the pocket.

The pet bed cushion of the second embodiment wherein the insert at least one pocket is oriented so that there are two pockets attached together such that they are attached on the long side of the pocket.

The pet bed cushion of the second embodiment wherein the aroma therapy disposable is selected from the group consisting or lavender, essential oils, Bergamot, Clary Sage, Peppermint, Eucalyptus, Lemon, Rosemary, Chamomile, Peppermint, vanilla, coconut, valerian, ginger, cannabis, catnip and Cannabidiol (CBD) oil.

The instant invention in a third embodiment can be described as a pet bed cushion comprising:
a. An insert made from a washable material and having at least one pocket, each of the at least one pocket having a pocket opening on a short side of the pocket that permits access into and out of the respective pocket and the at least one pocket being joined at a long side of the pocket to a second at least one pocket long side and the at least one pocket being joined at the opposing short side of the pocket opening;
b. the at least one pocket configured to removably receive a pillow/support material therein forming said pet bed cushion therewith;
c. the at least one pocket having a closure mechanism to close the pocket when the pillow/support material is received within the pockets;
d. each pillow/support material being removably held in a corresponding at least one pocket such that each pillow/support material is removable from and replaceable into the at least one pocket through the corresponding pocket opening; and
e. said pet bed cushion fitting into a duvet

The pet bed cushion of the third embodiment wherein the insert closure mechanism is selected from the group consisting of buttons and buttonholes, loop and hook closure, snaps, zipper or a lace and holes closure mechanism.

The pet bed cushion of the third embodiment wherein the insert washable material is selected from the group consisting of linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

The pet bed cushion of the third embodiment wherein the insert at least one pocket is oriented so that there are two pockets attached together such that they are attached on the short side of the pocket.

The pet bed cushion of the third embodiment wherein the insert with at least one pocket is oriented so that there are two pockets attached together such that they are attached on the long side of the pocket.

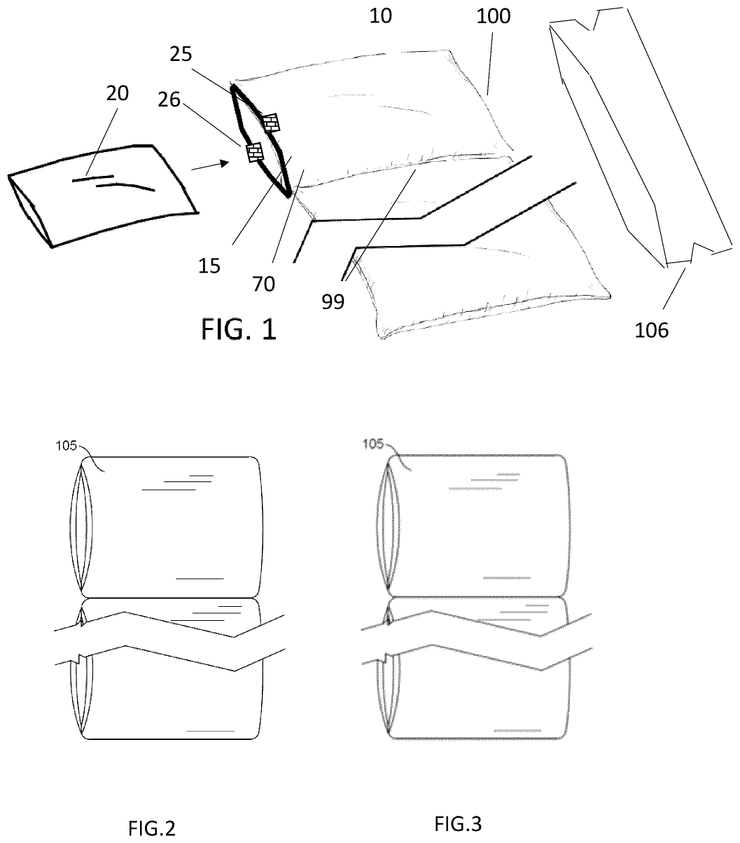

Referring now to the drawings FIGS. 1-34, and more particularly to FIG. 1, there is shown a left front top perspective view of a first embodiment of the pet bed cushion 105 (shown in FIG. 2) of the instant invention comprising insert 10 with opening 15 and pillow 20 which forms pet bed cushion 105 shown in FIG. 2. Opening 15 is the open side of the at least two pockets and accommodates the insertion or removal of pillow 20 into insert 10 and opening 15 has closure mechanism 25 and closure mechanism 26. The pillow 20 fits in pocket 70. The at least two pockets can have two long sides 99 and a short side 100 which are formed by sewing opposing material to form the pocket or the least two pockets can have three short sides which are formed by sewing opposing material to form the pocket. Alternatively, the at least two pockets can have three long sides which are formed by sewing opposing material to form the pocket The pockets can be oriented so that the pockets are in communication with a short side of the pockets, the long side of the pockets, or the short side and long side of the pockets. As shown in FIG. 1 pockets are joined at said long side. The pet bed cushion 105 shown in FIG. 2 can be placed in duvet 106.

FIG. 2 is a top plan view showing pet bed cushion 105 of the pet bed cushion of the instant invention shown in FIG. 1.

FIG. 3 is a bottom plan view showing pet bed cushion 105 of the pet bed cushion of the instant invention shown in FIG. 1.

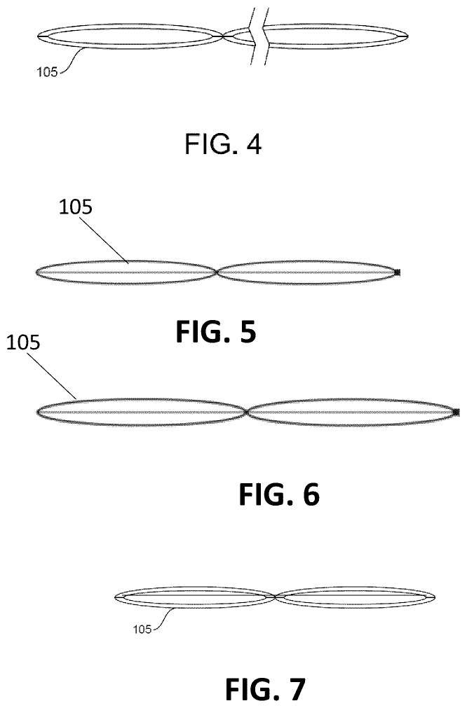

FIG. 4 is a left side elevational view showing pet bed cushion 105 of the pet bed cushion of the instant invention shown in FIG. 1.

FIG. 5 is a front elevational view showing pet bed cushion 105 of the pet bed cushion of the instant invention shown in FIG. 1.

FIG. 6 is a right-side elevational view showing pet bed cushion 105 of the pet bed of the instant invention shown in FIG. 1.

FIG. 7 is a rear elevational view showing pet bed cushion 105 of the pet bed cushion of the instant invention shown in FIG. 1.

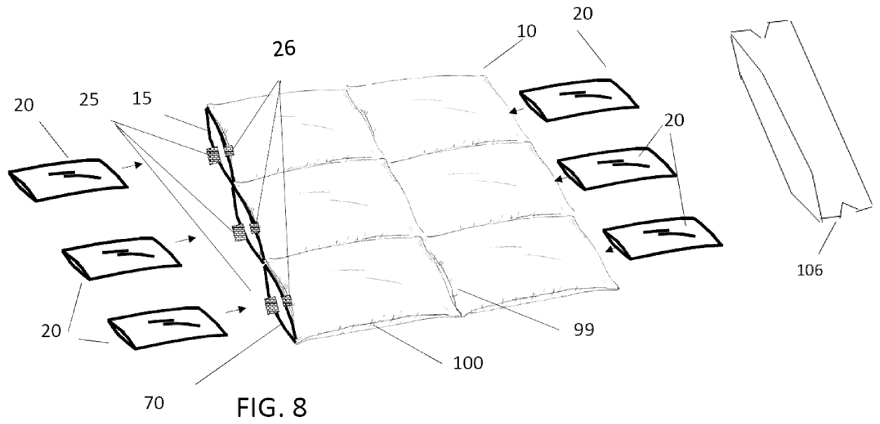

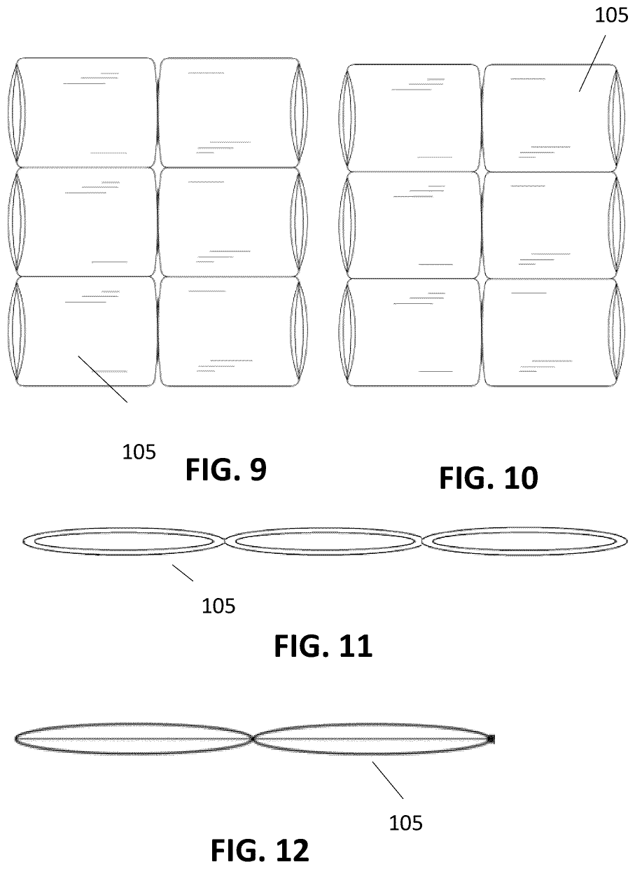

FIG. 8 is a left front top perspective view of a second embodiment of the pet bed cushion 105 shown in FIG. 9 of the instant invention showing the left side pillow, opening and closure mechanisms. The insert 10, opening 15 formed by the insert 10 that forms at least two pockets, pillow 20 and closure mechanism 25 and closure mechanism 26 for the left side are shown and the pillow 20 for the right side are shown. The pillow 20 fits in pocket 70. The at least two pockets can have two long sides 99 and a short side 100 which are formed by sewing opposing material to form the pocket or the least two pockets can have three short sides which are formed by sewing opposing material to form the pocket. Alternatively, the at least two pockets can have three long sides which are formed by sewing opposing material to form the pocket The pockets can be oriented so that the pockets are in communication with a short side of the pockets, the long side of the pockets, or the short side and long side of the pockets. As shown in FIG. 8 said pockets are joined at said opposing short side from said opening 15 and at said long sides. The pet bed cushion 105 shown in FIG. 9 can be placed in duvet 106.

FIG. 9 is a top plan view of the pet bed cushion 105 of the instant invention shown in FIG. 8.

FIG. 10 is a bottom plan view of the pet bed cushion 105 of the instant invention shown in FIG. 8.

FIG. 11 is a left side elevational view of the pet bed cushion 105 of the instant invention shown in FIG. 8.

FIG. 12 is a front elevational view of the pet bed cushion 105 of the instant invention shown in FIG. 8.

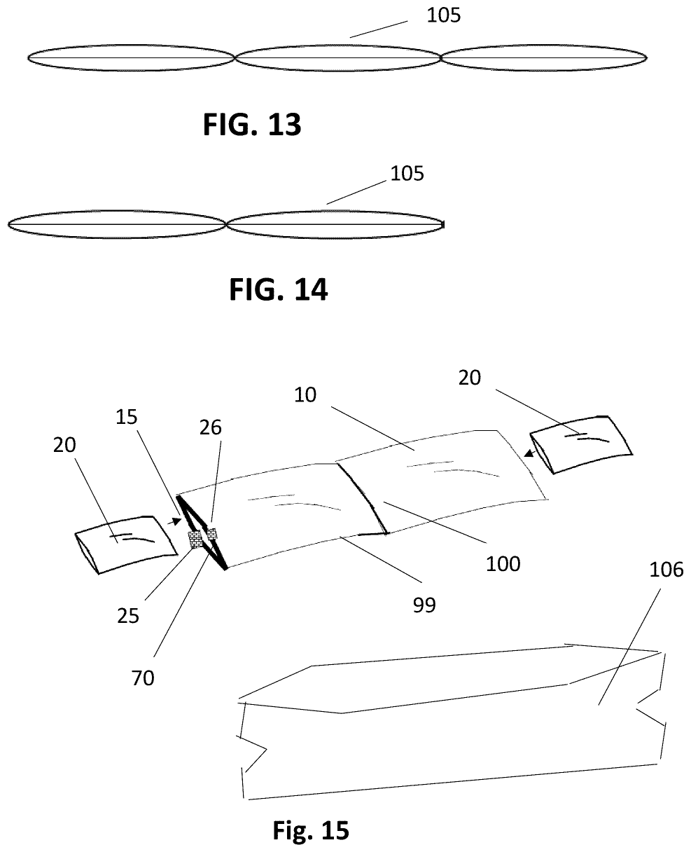

FIG. 13 is a right-side elevational view of the pet bed cushion 105 of the instant invention shown in FIG. 8.

FIG. 14 is a rear elevational view of the pet bed of the instant invention shown in FIG. 8 showing pet bed cushion 105.

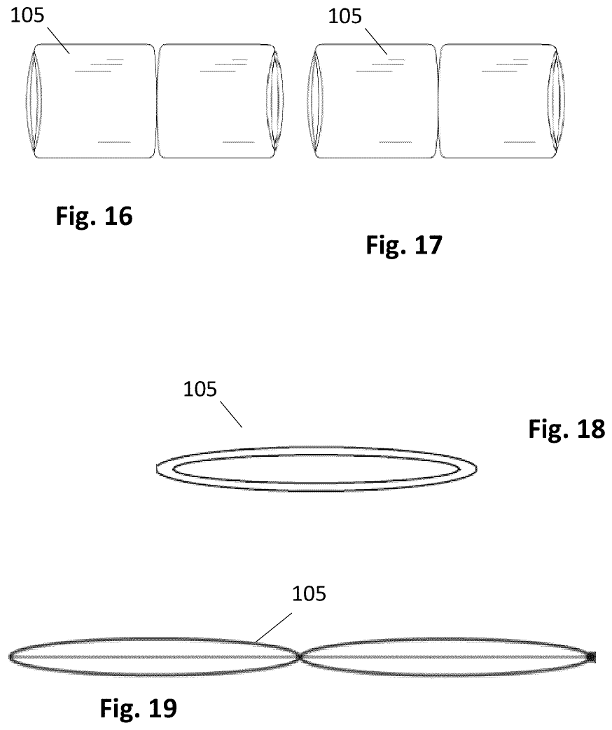

FIG. 15 is a left front top perspective view of a third embodiment of the pet bed cushion 105 shown in FIG. 16 comprising insert 10, opening 15 formed by the insert 10 that forms at least two pockets, pillow 20 and closure mechanism 25 and closure mechanism 26 for the left side are shown and the pillow 20 for the right side is shown. The at least two pockets can have two long sides 99 and a short side 100 which are formed by sewing opposing material to form the pocket or the least two pockets can have three short sides which are formed by sewing opposing material to form the pocket. Alternatively, the at least two pockets can have three long sides which are formed by sewing opposing material to form the pocket The pockets can be oriented so that the pockets are in communication with a short side of the pockets, the long side of the pockets, or the short side and long side of the pockets. As shown in FIG. 15 said pockets are joined at said opposing short side from said opening 15. The pet bed cushion 105 shown in FIG. 16 can be placed in duvet 106.

FIG. 16 is a top plan view of the pet bed cushion 105 of the instant invention shown in FIG. 15.

FIG. 17 is a bottom plan view of the pet bed cushion 105 of the instant invention shown in FIG. 15.

FIG. 18 is a left side elevational view of the pet bed cushion 105 of the instant invention shown in FIG. 15.

FIG. 19 is a front elevational view of the pet bed cushion 105 of the instant invention shown in FIG. 15.

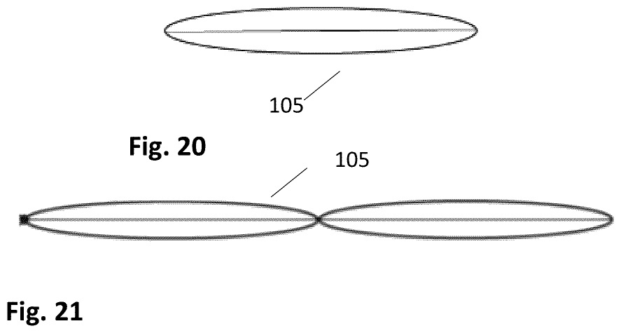

FIG. 20 is a right-side elevational view of the pet bed cushion 105 of the instant invention shown in FIG. 15.

FIG. 21 is a rear elevational view of the pet bed cushion 105 of the instant invention shown in FIG. 15.

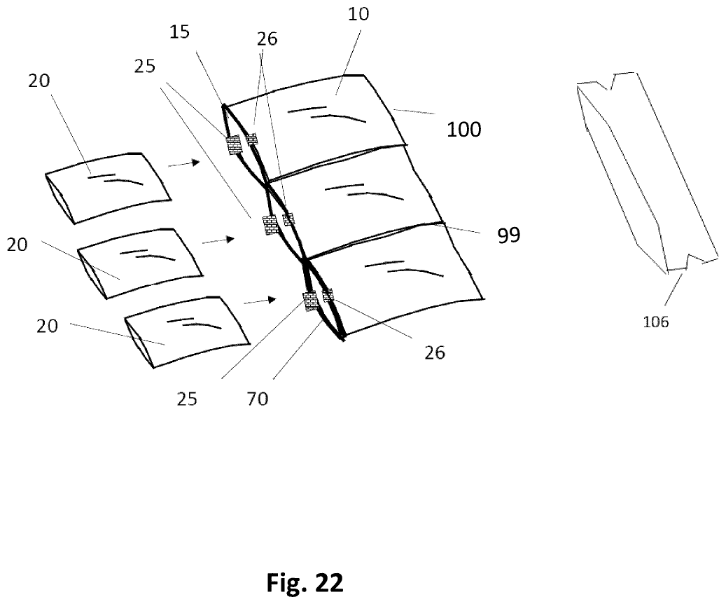

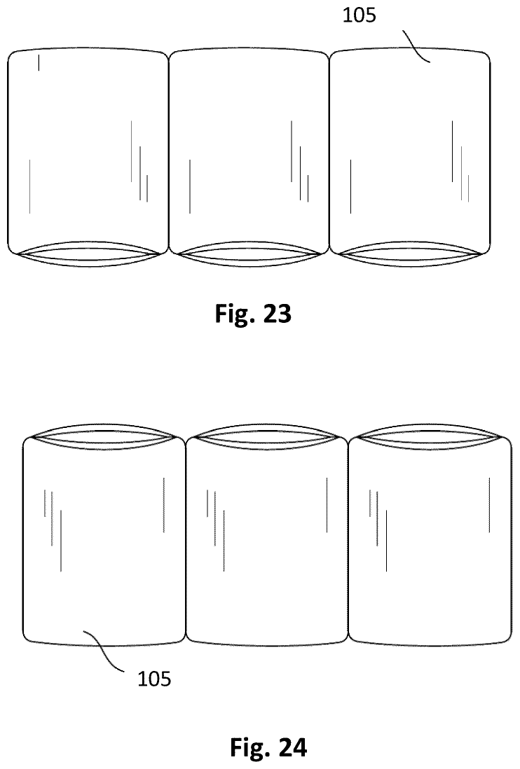

FIG. 22 is a left front top perspective view of a third embodiment of the pet bed cushion 105 shown in FIG. 23 of the instant invention comprising insert 10, opening 15 formed by the insert 10 that forms at least two pockets, pillow 20 and closure mechanism 25 and closure mechanism 26 for the left side is shown. The pillow 20 fits in pocket 70. The at least two pockets can have two long sides 99 and a short side 100 which are formed by sewing opposing material to form the pocket or the least two pockets can have three short sides which are formed by sewing opposing material to form the pocket. Alternatively, the at least two pockets can have three long sides which are formed by sewing opposing material to form the pocket The pockets can be oriented so that the pockets are in communication with a short side of the pockets, the long side of the pockets, or the short side and long side of the pockets. As shown in FIG. 22 said pockets are joined at said long sides. The pet bed cushion 105 shown in FIG. 23 can be placed in duvet 106.

FIG. 23 is a top plan view of the pet bed cushion 105 of the instant invention shown in FIG. 22.

FIG. 24 is a bottom plan view of the pet bed cushion 105 of the instant invention shown in FIG. 22.

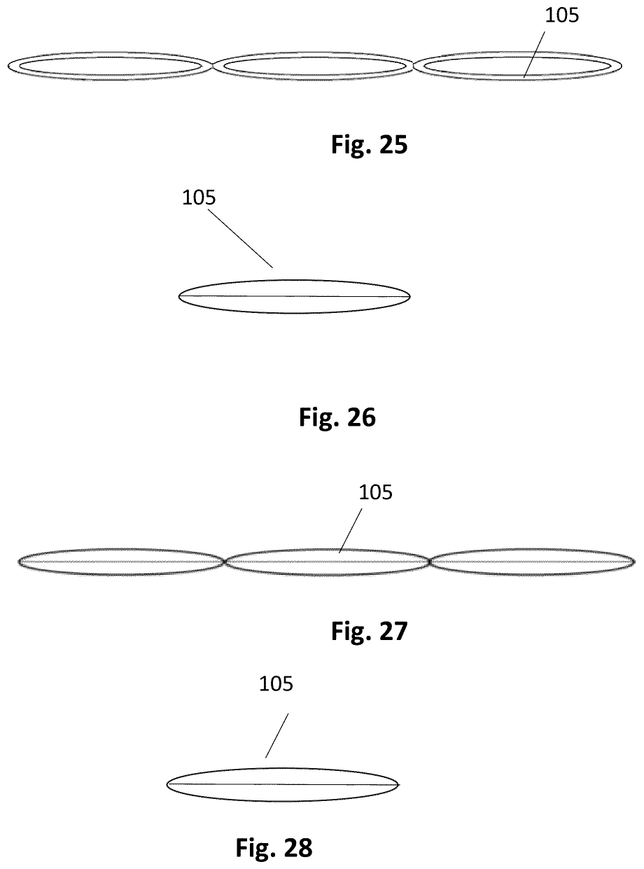

FIG. 25 is a left side elevational view of the pet bed cushion 105 of the instant invention shown in FIG. 22.

FIG. 26 is a front elevational view of the pet bed cushion 105 of the instant invention shown in FIG. 22.

FIG. 27 is a right-side elevational view of the pet bed cushion 105 of the instant invention shown in FIG. 22.

FIG. 28 is a rear elevational view of the pet bed cushion 105 of the instant invention shown in FIG. 22.

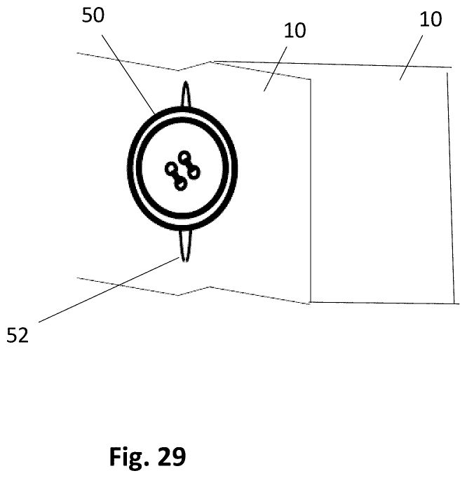

FIG. 29 is shown a closure for the insert 10 formed from a button 50 and buttonhole 52;

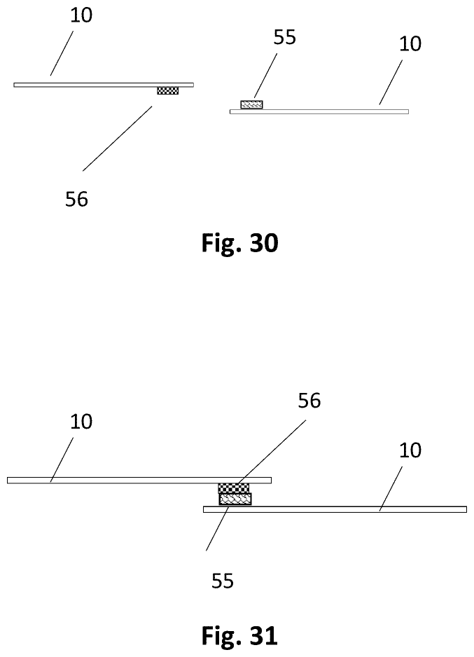

FIG. 30 is shown a side view of a closure in the unclosed state formed from a loop and hook closure mechanism and the insert 10 has loop mechanism 55 which corresponds to closure mechanism 25 shown in FIG. 1 and hook mechanism 56 which corresponds to closure mechanism 26 shown in FIG. 1.

FIG. 31 is shown a side view of a closure in the closed state formed from a loop and hook closure mechanism and the insert 10 has loop mechanism 55 which corresponds to closure mechanism 25 shown in FIG. 1 and hook mechanism 56 which corresponds to closure mechanism 26 shown in FIG. 1.

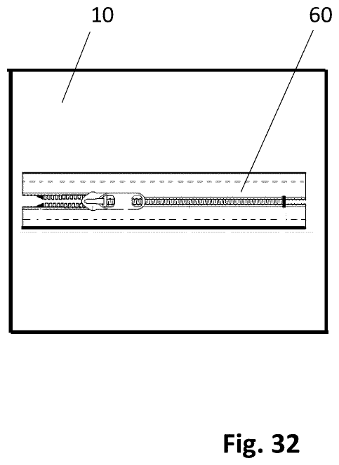

FIG. 32 is shown a closure formed from a zipper 60 in insert 10.

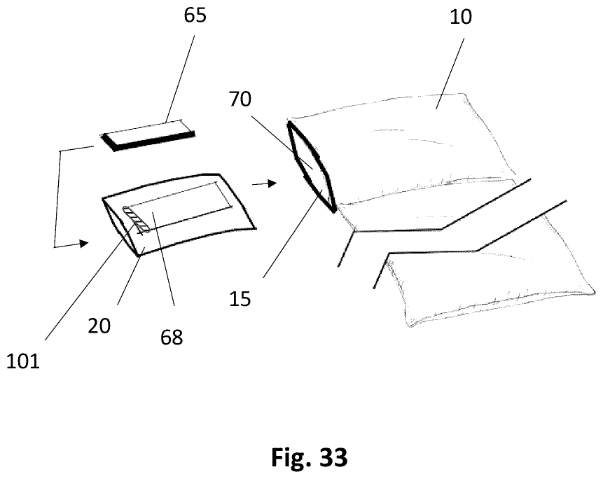

FIG. 33 is shown a view of the instant invention with optional aroma therapy disposable 65 and pillow 20 with aroma therapy insert pocket 68. The aroma therapy disposable 65 is placed between the pillow 20 or cushion and the inside of the pocket 70 of the insert 10. The aroma therapy insert can fit in an aroma therapy pocket 68 having opening 101 or placed loosely into the insert 10 so that the aroma therapy insert can emit the scent for the pet to smell. The aroma therapy disposable 65 can contain any of the following or a combination of substances including but not limited to lavender, essential oils, Bergamot, Clary Sage, Peppermint, Eucalyptus, Lemon, Rosemary, Chamomile, Peppermint, vanilla, coconut, valerian, ginger, cannabis, catnip and Cannabidiol (CBD) oil.

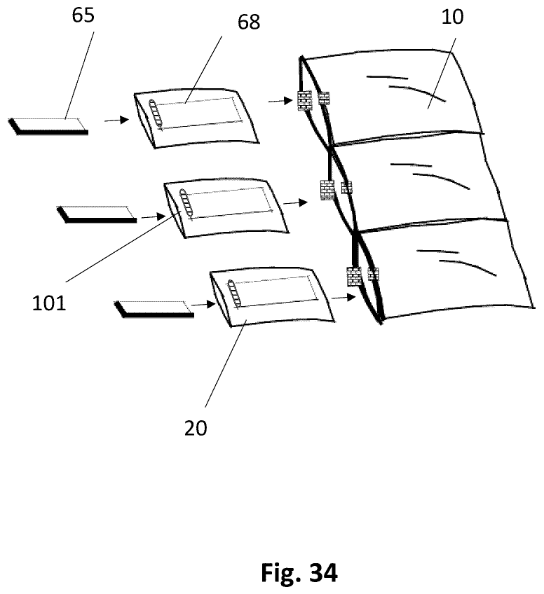

FIG. 34 is a kit of the instant invention. The kit includes an insert 10, at least one pillow 20, at least one aroma therapy pocket 68 having opening 101, at least one aroma therapy disposable 65.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A pet bed cushion comprising:
a. an insert made from a washable material and said insert having an open fastenable end, into which a pillow/support material is placed and said insert has at least one pocket having a pocket opening on a short side and said at least one pocket being joined at an opposing short side of said at least one pocket;
b. said pocket configured to removably receive a pillow/support material therein forming said pet bed cushion therewith;
c. said pocket configured to removably receive an aroma therapy disposable;
d. said pocket having a closure mechanism to close said pocket when a pillow/support material is received within said pockets; and
e. said pillow/support material removably held in said insert corresponding said pocket such that said pillow/support material is removable from and replaceable into said pocket through said pocket opening.

2. The pet bed cushion of claim 1 wherein said closure mechanism is selected from the group consisting of buttons and buttonholes, loop and hook closure, snaps, zipper or a lace and holes closure mechanism.

3. The pet bed cushion of claim 1 wherein said washable material is selected from the group consisting of linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

4. The pet bed cushion of claim 1 wherein said at least one pocket is oriented so that a first at least one pocket is attached to a second at least one pocket such that they are attached on the short side of the pocket.

5. The pet bed cushion of claim 1 wherein said at least one pocket is oriented so that there are two pockets attached together such that they are attached on the long side of the pocket.

6. The pet bed cushion of claim 1 wherein said aroma therapy disposable is selected from the group consisting of lavender, essential oils, Bergamot, Clary Sage, Peppermint, Eucalyptus, Lemon, Rosemary, Chamomile, Peppermint, vanilla, coconut, valerian, ginger, cannabis, catnip and Cannabidiol (CBD) oil.

7. A pet bed cushion comprising:
a. an insert made from a washable material and said insert having at least one pocket and said at least one pocket having a pocket opening on a short side of said at least one pocket that permits access into and out of the said at least one pocket and said at least one pocket being joined at a long side of said at least one pocket to a second at least one pocket long side;
b. said at least one pocket configured to removably receive a pillow/support material therein forming said pet bed cushion therewith;
c. said at least one pocket configured to removably receive an aroma therapy insert;
d. said at least one pocket having a closure mechanism to close said at least one pocket when said pillow/support material is received within said at least one pocket; and
e. said pillow/support material being held in at least one pocket such that said pillow/support material is removable from and replaceable into said at least one pocket through said pocket opening.

8. The pet bed cushion of claim 7 wherein said closure mechanism is selected from the group consisting of buttons and buttonholes, loop and hook closure, snaps, zipper or a lace and holes closure mechanism.

9. The pet bed cushion of claim 7 wherein said washable material is selected from the group consisting of linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

10. The pet bed cushion of claim 7 wherein said at least one pocket is oriented so that there are two pockets attached together such that they are attached on the short side of the pocket.

11. The pet bed cushion of claim 7 wherein said at least one pocket is oriented so that there are two pockets attached together such that they are attached on the long side of the pocket.

12. The pet bed cushion of claim 7 wherein said aroma therapy insert is selected from the group consisting of lavender, essential oils, Bergamot, Clary Sage, Peppermint, Eucalyptus, Lemon, Rosemary, Chamomile, Peppermint, vanilla, coconut, valerian, ginger, cannabis, catnip and Cannabidiol (CBD) oil.

13. A pet bed cushion comprising:
a. an insert made from a washable material and having at least one pocket and said at least one pocket having a pocket opening on a short side of said pocket that permits access into and out of said at least one pocket and said at least one pocket being joined at a long side of said at least one pocket to a second at least one pocket long side and said at least one pocket being joined at said opposing short side of said at least one pocket;
b. said at least one pocket configured to removably receive a pillow/support material therein forming said pet bed cushion therewith;
c. said at least one pocket having a closure mechanism to close said at least one pocket when said pillow/support material is received within said pockets; and
d. each pillow/support material removably held in said at least one pocket such that said pillow/support material is removable from and replaceable into said at least one pocket through said pocket opening.

14. The pet bed cushion of claim 13 wherein said closure mechanism is selected from the group consisting of buttons and buttonholes, loop and hook closure, snaps, zipper or a lace and holes closure mechanism.

15. The pet bed cushion of claim 13 wherein said washable material is selected from the group consisting of linen, denim, flannel, stretch fabric, polar fleece, ticking, terrycloth, velour, chino cloth, felt, shag, ballistic nylon, burlap, corduroy, Gore-Tex, leather, Poplin, sailcloth or vinyl coated polyester (PVC).

16. The pet bed cushion of claim 13 wherein said at least one pocket is oriented so that there are two pockets attached together such that they are attached on the short side of the pocket.

17. The pet bed cushion of claim 13 wherein said at least one pocket is oriented so that there are two pockets attached together such that they are attached on the long side of the pocket.
